(19) United States
(12) Patent Application Publication
(10) Pub. No.: US 2011/0158892 A1
(43) Pub. Date: Jun. 30, 2011

(54) PROCESS FOR PRODUCING CARBON NANOMATERIAL AND SYSTEM FOR PRODUCING CARBON NANOMATERIAL

(75) Inventor: Takanobu Yamaki, Oita (JP)

(73) Assignee: SHOWA DENKO K.K., Minato-ku, Tokyo (JP)

(21) Appl. No.: 13/002,279

(22) PCT Filed: Jun. 30, 2009
(86) PCT No.: PCT/JP2009/062255

§ 371 Date: Mar. 9, 2011

(30) Foreign Application Priority Data
Jun. 30, 2008 (JP) 2008-170445

(51) Int. Cl. C01B 31/02; B01J 8/18; B82Y 40/00

(52) U.S. Cl. 423/445 R; 422/139; 977/896

(57) ABSTRACT

A process for producing a carbon nanomaterial, including fluidizing a carbon raw material, a catalyst and a fluidizing material in a fluidized bed reactor to produce the carbon nanomaterial, wherein the fluidizing material is a carbon material. A carbon nanomaterial production system for producing a carbon nanomaterial including a fluidized bed reactor for fluidizing a car-bon raw material, a catalyst and a fluidizing material to carry out the reaction thereof, a carbon raw material feeding device for feeding the carbon raw material to the fluidized bed reactor, a catalyst feeding device for feeding the catalyst to the fluidized bed reactor, and a recovering device for recovering the produced carbon nanomaterial from the fluidized bed reactor, wherein a part of the recovered carbon nanomaterial is transferred to the catalyst feeding device and used as the fluidizing material.

### TECHNICAL FIELD

The present invention relates to a process for producing a carbon nanomaterial and to a system for producing a carbon nanomaterial.

### BACKGROUND ART

The presence of multi-layer carbon nanotubes in lumps of carbon deposited on a cathode during an arc discharge process was discovered in 1991 by Iijima.

Typical methods for producing carbon nanotubes include an arc discharge method, a laser evaporation method and a chemical vapor phase deposition method. The chemical vapor phase deposition (CVD) method is known to be an effective mass production method for carbon nanotubes. Carbon nanotubes are generally produced by contacting a carbon-containing gaseous raw material with fine particles of a metal such as iron or nickel at a high temperature ranging from 400° C. to 1,000° C.

As a CVD method, there is known a method (catalytic CVD) wherein a metal catalyst is supported on a carrier by utilizing its structure. Silica, alumina, magnesium oxide, titanium oxide, silicate, diatomaceous earth, alumina silicate, silica-titania, zeolite, etc., are used as the carrier for the catalytic CVD method. The solid catalyst using such a carrier is generally used as such in the form of a powder for the production of carbon nanotubes.

Methods hitherto proposed include a method for producing carbon nanotubes using a fluidized bed as a production device utilizing a catalytic CVD method (Patent Document 1), a method in which a fluidizing material is separated in a separating device from carbon nanofibers after completion of the reaction, and the separated fluidizing material being recycled and used in the reaction (Patent Document 2), a method for producing carbon nanotubes in a fluidized bed using a catalyst-and-fluidizing material obtained by bonding a metal catalyst-supporting carrier with a binder (Patent Document 3), and a method capable of producing carbon nanotubes using a fluidized bed, a rotary kiln or the like device by using, together with a fluidizing material, a carrier which is inert to the reaction for production of the carbon nanotubes and which is not fluidizable by itself (Patent Document 4).

### PRIOR ART DOCUMENTS

### Patent Documents

Patent Document 1: JP3369996 C
Patent Document 2: JP4064758 C
Patent Document 3: JP2003-342840 A
Patent Document 4: JP2008-56523 A

### SUMMARY OF THE INVENTION

### Problems to Be Solved by the Invention

In a catalytic CVD method, a carrier is mainly used for the purpose of controlling a particle size of the catalytic metal particles. However, a selected carrier is not always utilizable in a fluidized bed. Even if a solid catalyst having remarkably improved carbon nanotube production efficiency is developed, it will be difficult to use such a catalyst in industrially advantageous production systems if the catalyst has a poor fluidizability.

When the fluidizability is poor, the solid catalyst may fail to sufficiently come into contact with the raw material gas and, therefore, the production efficiency tends to be deteriorated. As a result, the proportion of the raw material gas which is discharged outside the reaction system without having been used for the reaction is increased so that the production cost increases. Further, poor fluidizability of the solid catalyst, the raw material gas, etc., may cause clogging of the system within a short period of time. For these reasons, a key factor in the catalytic CVD method using a fluidized bed reaction is to ensure a good fluidizability of the solid catalyst, the raw material gas, etc.

Reviewing the above-described patent documents, Patent Document 1 describes a fluidized bed but does not disclose a concrete method thereof. In Patent Document 2, the product and fluidizing material are separated in the separating device. However, it is considered to be practically impossible to completely separate them from each other. The fluidizing material is included as contaminates in the product so that the purity of the product tends to be reduced. In Patent Document 3, it is proposed that the solid catalyst is molded using a binder for the purpose of ensuring a good fluidizability thereof. In this case, however, no carbon nanotubes may be produced at a temperature higher than the decomposition temperature of the binder. Further, a multi-stage process is required in order to obtain the catalyst, which unavoidably causes increase in the production costs. In Patent Document 4, there is proposed a method in which a carrier which is not fluidizable or hardly fluidizable, is easily fluidized by adding a fluidizing material such as magnesia, alumina or titanium oxide thereto. Similarly to Patent Document 2, however, it is necessary to conduct a step of separating the fluidizing material and the carbon material from each other.

In view of the above conventional problems, it is an object of the present invention to provide a process and a system for producing a carbon nanomaterial which can ensure a sufficient fluidizability of a catalyst, a carbon raw material, etc., at the time of performing a catalytic reaction, which does not require a step of separating the produced carbon nanomaterial from a fluidizing material, and which can produce the carbon nanomaterial having high purity with a high efficiency.

The term “carbon nanomaterial” as used herein refers to a carbon material of a nano or micron order and is preferably a carbon material which has a diameter of a nano meter order and a length of a few micron orders to a few hundred micron orders micron order and which is obtained by catalytic reaction of a carbon raw material fed. Such a carbon material has various shapes such as a fibrous form and a tubular form.

### Means for Solving the Problems

As a result of an earnest study for solving the above problems, the present inventors have found that the problems can be solved by the present invention as mentioned below. That is, the present invention relates to the following aspects.

[1] A process for producing a carbon nanomaterial, comprising fluidizing a carbon raw material, a catalyst and a fluidizing material in a fluidized bed reactor to produce the carbon nanomaterial, wherein a carbon material is used as the fluidizing material.
[2] The process for producing a carbon nanomaterial as recited in the above aspect [1], wherein the carbon material is a carbon nanomaterial separately obtained by the process recited in the above aspect [1].
[3] The process for producing a carbon nanomaterial as recited in the above aspect [1] or [2], wherein the carbon material is a carbon nanotube.
[4] The process for producing a carbon nanomaterial as recited in any one of the aspect [1] to [3], wherein a fluidizing gas is fed to the fluidized bed reactor.
[5] The process for producing a carbon nanomaterial as recited in any one of the above aspects [1] to [4], wherein the fluidizing material has been previously fluidized in the fluidized bed reactor before initiating a reaction for production of the carbon nanomaterial.
[6] The process for producing a carbon nanomaterial as recited in the above aspect [4] or [5], wherein the carbon raw material and the fluidizing gas have been previously heated before being fed to the fluidized bed reactor.
[7] The process for producing a carbon nanomaterial as recited in any one of the above aspects [1] to [6], wherein the carbon material used as the fluidizing material has a BET specific surface area of 10 m²/g or more and 1,500 m²/g or less.
   [8] The process for producing a carbon nanomaterial as recited in any one of the above aspects [1] to [7], wherein the carbon material used as the fluidizing material has a graphite layer.
   [9] The process for producing a carbon nanomaterial as recited in any one of the above aspects [1] to [8], wherein the carbon material used as the fluidizing material has a volume average particle diameter of 10 μm or more and 1,000 μm or less.
   [10] The process for producing a carbon nanomaterial as recited in any one of the above aspects [1] to [9], wherein the carbon material used as the fluidizing material has a true density of 1.70 g/cm³ or more.
   [11] The process for producing a carbon nanomaterial as recited in any one of the above aspects [1] to [10], wherein the carbon material used as the fluidizing material is granulated.
   [12] The process for producing a carbon nanomaterial as recited in any one of the above aspects [1] to [8] and [10], wherein the fluidizing material is a fibrous carbon material.
   [13] The process for producing a carbon nanomaterial as recited in the above aspect [12], wherein the fibrous carbon material has an aspect ratio of 1,000 or more.
   [14] The process for producing a carbon nanomaterial as recited in any one of the above aspects [1] to [13], wherein the catalyst and the fluidizing material have been previously mixed with each other before being introduced into the fluidized bed reactor and wherein the proportion of the fluidizing material is 40% by mass or more and 90% by mass or less on the basis of the total mass of the catalyst and the fluidizing material.
   [15] A carbon nanomaterial production system for producing a carbon nanomaterial by the process as recited in any one of the above aspects [1 ]to [14], comprising a fluidized bed reactor for fluidizing a carbon raw material, a catalyst and a fluidizing material and carrying out a reaction thereof, a carbon raw material feeding device for feeding the carbon raw material to the fluidized bed reactor, a catalyst feeding device for feeding the catalyst to the fluidized bed reactor, and a recovering device for recovering the produced carbon nanomaterial from the fluidized bed reactor, wherein a part of the recovered carbon nanomaterial is transferred to the catalyst feeding device and used as the fluidizing material.
   [16] The carbon nanomaterial production system as recited in the above aspect [15], wherein the catalyst feeding device comprises a pneumatic transfer means that conveys a mixture of the fluidizing material and particles of the catalyst to the fluidized bed reactor by pneumatic transfer.
   [17] The carbon nanomaterial production system as recited in any one of the above aspect [15] or [16], wherein the recovering device comprises a recovering pipe that is moveable up and down in the vertical direction.

### Effect of the Invention

According to the present invention, it is possible to provide a process and a system for producing a carbon nanomaterial which can ensure a sufficient fluidizability of a catalyst, a carbon raw material, etc., at the time of performing a catalytic reaction, which does not require a step of separating the produced carbon nanomaterial from a fluidizing material, and which can produce the carbon nanomaterial having high purity with a high efficiency.

### BRIEF DESCRIPTION OF THE DRAWINGS

FIG. 1 is a schematic view showing an example of a system for producing a carbon nanomaterial according to the present invention.

FIG. 2 is an electron microphotograph of a carbon nanomaterial (carbon nanotubes) produced in Example 1.

### EMBODIMENTS FOR CARRYING OUT THE INVENTION

The process for producing a carbon nanomaterial according to the present invention includes fluidizing a carbon raw material, a catalyst and a fluidizing material in a fluidized bed reactor to produce the carbon nanomaterial, wherein a carbon material is used as the fluidizing material.

The present invention does not use an ordinary material such as silica sand or alumina as a fluidizing material for forming the fluidized bed, but uses a carbon material produced by the reaction as the fluidizing material. Therefore, it is possible not only to omit a separation step for separating the produced carbon nanomaterial from the fluidizing material which step would be required if alumina, silica sand or the like is used as the fluidizing material, but also to obtain a carbon nanomaterial with a high purity. It is particularly preferred that the carbon material be a carbon nanomaterial separately obtained as a product of the reaction in the fluidized bed reactor and be reused.

The fluidizability of the solid catalyst which is a key factor in the catalytic CVD method can be ensured by using the carbon material as the fluidizing material. In particular, by using a suitable mixing ratio between the carbon material and the catalyst, a fluidized bed suited for the reaction can be formed. As a consequence, vigorous stirring by the fluidizing material is achieved within the fluidized bed reactor so that the catalyst can exist uniformly and the contacting efficiency between the catalyst and the carbon raw material can be enhanced, namely, the reaction can proceed uniformly.

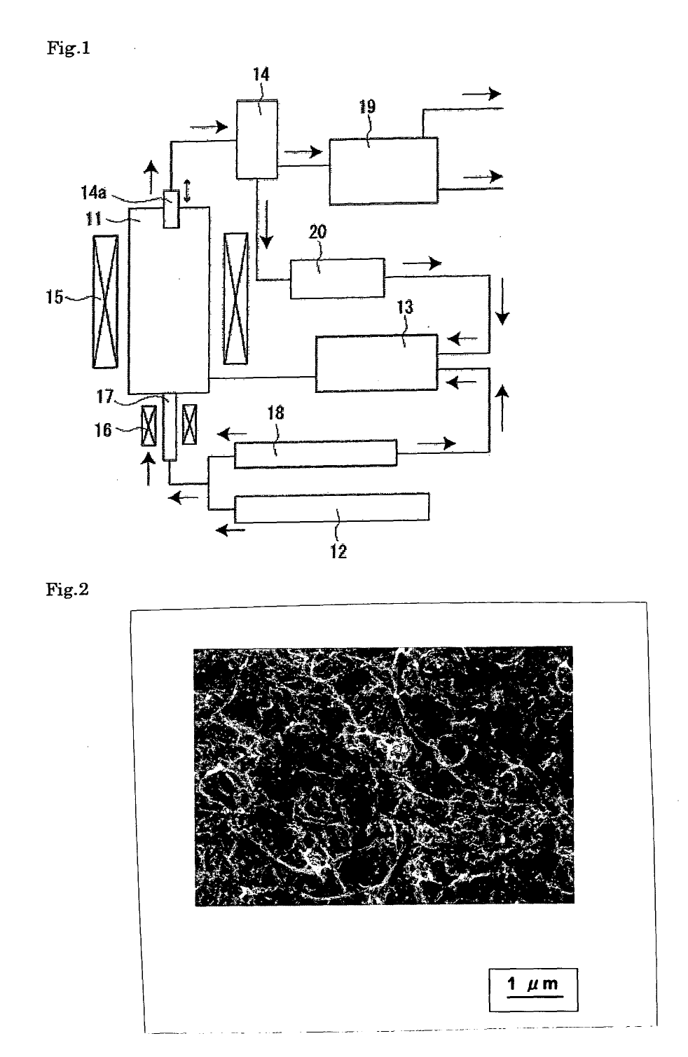

The present invention will be described in detail below with reference to FIG. 1 which shows an example of a carbon nanomaterial production system suitably used to carry out the process for producing a carbon nanomaterial according to the present invention.

As shown in FIG. 1, the system for producing a carbon nanomaterial according to the present invention includes a fluidized bed reactor 11 configured to fluidize a carbon raw material, a catalyst and a fluidizing material and to carry out the reaction thereof, a carbon raw material feeding device 12 for feeding the carbon raw material to the fluidized bed reactor 11, a catalyst feeding device 13 for feeding the catalyst to the fluidized bed reactor 11, and a recovering device 14 for recovering the produced carbon nanomaterial from the fluidized bed reactor.

The process for producing a carbon nanomaterial using the production system is carried out as follows. First, the carbon raw material and the catalyst are fed to the fluidized bed reactor 11 from the carbon raw material feeding device 12 and the catalyst feeding device 13, respectively. In this case, the fluidizing material may be previously filled in the fluidized bed reactor 11. Alternatively, the fluidizing material may be previously received in the catalyst feeding device 13 in a predetermined mass ratio and fed to the fluidized bed reactor 11 together with the catalyst.

In this case, before initiating the reaction for production of the carbon nanomaterial, the fluidizing material may be previously fluidized in the fluidized bed reactor 11. More specifically, the fluidizing material may be previously maintained in a fluidized state in the fluidized bed reactor 11 using a fluidizing gas before feeding the carbon material and the catalyst thereto. Further, the fluidizing material is preferably maintained in a fluidized state using the fluidizing gas which has been heated in a preheating section 17.

The carbon raw material and the catalyst fed to the fluidized bed reactor 11 are heated with a heater 15 to a predetermined temperature. In this case, it is preferred that the carbon raw material and the catalyst be subjected to heating treatment in the preheating section 17 provided with a heater 16 before being fed to the fluidized bed reactor 11.

The carbon raw material, catalyst and fluidizing material fed to the fluidized bed reactor 11 and heated to the predetermined temperature are fluidized by any known method and subjected to a catalytic reaction in a lower portion (fluidized reaction zone) of the fluidized bed reactor 11. The fluidization method is not particularly limited. For example, the fluidizing gas may be supplied from a fluidizing gas feeding device 18 to the fluidized bed reactor 11 for fluidizing the above materials.

In this case, it is preferred that the carbon raw material and the fluidizing gas be preheated before being supplied to the fluidized bed reactor. The preheating temperature is preferably a temperature described hereinafter.

The carbon nanomaterial as the reaction product is recovered from an upper portion of the fluidized bed reactor 11 by a recovering device 14. Various methods may be used for the recovery by the recovering device. For example, it is preferable to use a recovering pipe 14a that is moveable up and down in the vertical direction within the fluidized bed reactor 11. The recovered carbon nanomaterial is introduced into a separating device 19 where it is separated from an exhaust gas and is recovered as a product. For the purpose of using the carbon nanomaterial as the fluidizing material, a part of the carbon nanomaterial is transferred through an intermediate hopper 20, etc., to the catalyst feeding device 13 where it is mixed with the catalyst and is thereafter recycled to the fluidized bed reactor 11.

As the type of the fluidized bed reaction in the fluidized bed reactor 11, there may be mentioned a bubbling fluidized bed and a turbulent fluidized bed. Either of the fluidized beds may be used for the purpose of the present invention. In one preferred embodiment of the present invention, the fluidized bed reactor 11 has a fluidized reaction zone in a lower part thereof where the catalytic reaction proceeds in a fluidized state and a free board zone above the fluidized reaction zone. In this case, it is preferred that the free board zone have a greater flow passage cross sectional area than that of the fluidized reaction zone, since it is easy to reduce the amount of scattering of particles.

The free board zone preferably has a greater flow passage cross sectional area than that of the fluidized reaction zone. In this case, it is also preferred that the boundary between the free board zone and the fluidized reaction zone be inclined at an angle greater than the angle of repose of the carbon nanomaterial to be recovered. An angle of the boundary greater than the angle of repose can prevent accumulation and solidification of scattered particles on the inclined surface.

The carbon raw material supplied from the carbon raw material feeding device 12 may be any substance as long as it is a carbon-containing compound. For example, hydrocarbons and alcohols which are in the form of a gas under the conditions under which carbon nanotubes are produced may be used.

Examples of the carbon raw material include, although not limited thereto, methane, ethane, ethylene, acetylene, propane, propylene, isopropylene, n-butane, butadiene, 1-butene, 2-butene, 2-methylpropane, n-pentane, 2-methylbutane, 1-pentene, 2-pentene, cyclopentane, cyclopentadiene, n-hexane, 1-hexene, 2-hexene, cyclohexane, cyclohexene, 2-methylpentane, 3-methylpentane, 2,2-dimethylbutane, 2,4-dimethylpentane, 3,3-dimethylpentane, 2,2,3-trimethylbutane, n-octane, isoocatane, cyclooctane, 1,1-dimethylcyclohexane, 1,2-dimethylcyclohexane, ethylcyclohexane, 1-octene, 2-methylheptane, 3-methylheptane, 4-methylheptane, 2,2-dimethylhexane, 2,4-dimethylhexane, 2,5-dimethylhexane, 3,4-dimethylhexane, 2,2,4-trimethylpentane, 2, 3,4-trimethylpentane, n-nonane, isopropylcyclohexane, 1-nonene, propylcyclohexane, 2,3-dimethylheptane, n-decane, butylcyclohexane, cyclodecane, 1-decene, pinene, pinane, limonene, n-undecane, 1-undecene, n-dodecane, cyclododecene, 1-dodecene, n-tridecane, 1-tridecene, n-tetradecane, 1-tetradecene, n-pentadecane, n-hexadecane, n-octadecane, n-nonadecane, eicosane, docosane, tetracosane, pentacosane, hexacosane, heptacosane, octacosane, nonacosane, benzene, toluene, xylene, ethylbenzene, diethylbenzene, vinyltolutene, mesitylene, pseudocumene, styrene, cumene, vinylstyrene and mixtures thereof. Organic compounds containing S components and Cl components in addition to C and H may also be used.

The carbon raw material may be used in the form of a mixture thereof with an inert gas or gases such as nitrogen, argon, hydrogen and helium. The combined use of the carbon raw material and inert gas enables the control of the concentration of the carbon raw material. The use of the inert gas is also preferable because it also functions as a carrier gas.

The catalytic reaction is preferably carried out in such a manner that the carbon raw material is brought into contact with the catalyst in a mixed gas having a hydrogen partial pressure in the range of 10% to 90% for a given period of time to produce the carbon nanomaterial. Hydrogen is supplied at the time of the reaction for the purpose of obtaining the above-described effect as a carrier gas as well as an effect of promoting the growth of the carbon nanomaterial grown on the catalyst.

The superficial velocity in the fluidized bed reactor 11 varies depending upon the particle size of the catalyst, the particle size of the fluidizing material and the kind of the fluid to be flown therethrough. It is, however, necessary to control the gas flow velocity to form a suitably functioned fluidized bed. Namely, the gas flow velocity is controlled within the range greater than the velocity for the start of fluidization of the particles and less than the terminal velocity.

The gas velocity is generally selected to ensure the optimum value which falls within the range of two to eight times the velocity for the start of fluidization. Namely, the superficial velocity provides a gas velocity which lies in the range of two to eight times the velocity for the start of fluidization. The system is constructed so that the gas velocity may be controlled to a given value and the selected optimum value may be maintained constant.

The carbon raw material used as a raw material is preferably preheated in the preheating section 17. The preheating temperature is preferably a temperature at which the carbon raw material is not decomposed and is preferably, for example, 800° C. or less. By conducting the preheating, it becomes easy to control the temperature within the fluidized bed reactor 11 as compared with the conventional case where the carbon raw material at room temperature is introduced into the reactor. Moreover, the reaction can efficiently proceed upon contact of the carbon raw material with the catalyst to produce the carbon nanomaterial with a high purity.

The carbon material used as the fluidizing material is not particularly limited. Examples of the carbon material include activated carbon, carbon black, graphitized carbon black, Ketjen black, graphite, graphite fine powder, fullerenes, carbon nanotubes, carbon fibers and graphitized carbon fibers. Among the above carbon materials, the carbon material which is the same as the intended reaction product is preferred. Further, the fluidizing material is preferably a fibrous carbon material. When the fluidizing material is a fibrous carbon material, the aspect ratio thereof is preferably 1,000 or more, and more preferably 3,000 or more. When the aspect ratio is 1,000 or more, it is easy to adjust a surface resistivity of composite materials to such a level as to prevent electrostatic charging even with a small amount of the carbon material added. It is more preferred that the carbon material have a graphite layer.

When carbon nanotubes are used as the fluidizing material, examples of the carbon nanotubes in view of their structure include single-walled nanotubes, double-walled nanotubes, multi-walled nanotubes, carbon nanohorns, carbon nanocoils and cup-stacked-type, although not particularly limited thereto. The configuration of the carbon nanotubes may be platelet, tubular, herringbone, fishbone, bamboo, etc., although not particularly limited thereto.

The fluidizing material preferably has a BET specific surface area in the range of 10 to 1,500 m²/g, more preferably in the range of 50 to 1,000 m²/g, and still more preferably in the range of 100 to 500 m²/g. The BET specific surface area used herein may be measured by the BET method using nitrogen adsorption.

The fluidizing material preferably has a volume average particle diameter of 10 μm or more and 1,000 μm or less, more preferably 25 μm or more and 800 μm or less, and still more preferably 45 μm or more and 500 μm or less. A volume average particle diameter of the fluidizing material of 1,000 μm or less can ensure a good fluidizability thereof, whereas a volume average particle diameter of 10 μm or more can prevent scattering thereof out of the system. The volume average particle diameter used herein may be measured by a laser diffraction method. For example, it is preferred that Microtrac HRA made by NIKKISO CO,.LTD be used for the measurement of the volume average particle diameter.

The carbon material preferably has a true density of 1.70 g/cm³ or more, and more preferably 1.90 g/cm³ or more. This is because as the true density of the carbon material becomes closer to the theoretical true density of graphite which is 2.26570 g/cm³, the obtained product is considered to have a higher degree of graphitization and a higher degree of crystallization and to show a good electric conductivity.

The catalyst is not particularly limited, and is suitably such a catalyst which contains a metal of the Group 3 to 12, preferably the Group 5 to 11, more preferably V, Mo, Fe, Co, Ni, Pd, Pt, Rh, W, Cu, etc., still more preferably Fe, Co and Ni. It is known that these metals are suited for the production of carbon nanotubes.

The above-described catalyst is preferably supported on a carrier. The carrier for supporting the catalyst may be known oxide particles such as alumina, magnesium oxide, titanium oxide, silicate, diatomaceous earth, alumina silicate, silica-titania and zeolite, or carbon materials. The carrier preferably has a particle diameter of 0.02 to 2 mm.

When carbon is used as the carrier, the material thereof is not particularly limited. Examples of the carbon include activated carbon, carbon black, graphitized carbon black, Ketjen black, graphite, graphite fine powder, fullerenes, carbon nanotubes, carbon fibers and graphitized carbon fibers. The shape of these materials is not particularly limited, and may be, for example, in the form of particles, scales, masses and fibers.

Only one kind or two or more kinds of catalysts may be supported on the carrier. However, it is preferable to support two or more kinds of catalysts. When two or more catalysts are supported, it is preferred that Fe, Ni, Co, Pt or Rh be combined with another metal. Most preferred is a combination of Fe with at least one of Ni, Co, V, Mo and Pd.

A precursor of the catalyst is not particularly limited and may be, for example, inorganic salts such as sulfates, acetates and nitrates; complex salts such as ethylenediamine tetraacetic acid complexes and acetylacetonato complexes; metal halides; and organic complex salts.

A method for supporting the catalyst is not particularly limited. There may be used, for example, a method (impregnation method) in which a solid carrier is immersed in a non-aqueous solution (for example, methanol solution) or an aqueous solution in which a salt (precursor) of a metal (catalyst) to be supported has been dissolved, followed by fully dispersing and mixing the solid carrier therein and then drying the dispersion, to thereby support the catalytic component on the carrier. Other methods include an equilibrium adsorption method and an ion exchange method.

The carrier preferably has a BET specific surface area of 10 m²/g or more, more preferably 50 to 500 m²/g, and still more preferably 100 to 300 m²/g. This is because when the specific surface area of the carrier is high, it becomes easier to support the catalyst thereon. The BET specific surface area used herein may be measured by the BET method using nitrogen adsorption. The amount of the metal (catalyst) supported on the carrier is preferably in the range of 0.5% by mass to 30% by mass.

The particle diameter of the supported catalyst is not specifically limited, and is preferably within the range of 0.01 to 5 mm and more particularly within the range of 0.04 to 2 mm. When the particle diameter of the supported catalyst is 0.01 mm or more, scattering of the catalyst out of the system can be prevented, whereas when the particle diameter of the supported catalyst is 5 mm or less, a good fluidizability thereof can be ensured. Additionally, when the particle diameter lies within the above-specified range, it is possible to vigorously stir the fluidized bed and, therefore, to form a uniform reaction field.

It is preferred that the proportion (blending proportion) of the fluidizing material be 40% or more and 90% or less on the basis of the total mass of the catalyst and the fluidizing material. When the fluidizing material is added to the catalyst in the above proportion before being introduced into the fluidized bed reactor, it is possible not only to ensure a good fluidizability but also to produce the product without reducing the catalyst performance.

As described previously, the fluidizing material is preferably previously fluidized before initiating the reaction. In this case, the catalyst and fluidizing material may be previously mixed with each other in the catalyst feeding device 13 before they are introduced into the fluidized bed reactor 11. The method of mixing the catalyst with the fluidizing material is not particularly limited. Namely, the catalyst and fluidizing material may be mixed with each other by any known mixing method. As the fluidizing gas, an inert gas such as nitrogen, hydrogen, helium or argon may be preferably used.

When the solid catalyst and fluidizing material (carbon material) are fed from the catalyst feeding device 13 to the fluidized bed reactor 11, it is preferable to adopt pneumatic transfer by fluidizing means using, for example, the fluidizing gas. In the present invention, although not particularly limited, the flow velocity of the fluidizing gas for the pneumatic transfer is at least 20 times the minimum velocity for the start of fluidization of the solid catalyst. When the flow velocity of the fluidizing gas for the pneumatic transfer is at least 20 times the minimum fluidization starting velocity, it is possible to smoothly transfer the catalyst and fluidizing material so that the feed amount of the catalyst and fluidizing material may be precisely determined.

The carbon nanomaterial production temperature is preferably in the range of 400 to 1,300° C., more preferably 500 to 1,000° C., and still more preferably 600 to 900° C. The carbon nanomaterial may be produced by contacting the carbon raw material with the catalyst for a predetermined period of time. By keeping the residence time constant, it is possible to stabilize a quality of the product.

The carbon raw material is fed in the form of a gas to the fluidized bed reactor 11, so that the reaction can proceed more uniformly with stirring by the carbon material as the fluidizing material, thereby allowing growth of the carbon nanomaterial. In the embodiment shown in FIG. 1, in order to establish a predetermined fluidization condition, the fluidizing gas is also introduced from the fluidizing gas feeding device 18 separately from the carbon material introduced from the carbon raw material feeding device 12.

The thus obtained carbon nanomaterial generally has a fiber outer diameter of 100 nm or less, preferably 80 nm or less, and more preferably 50 nm or less. The reason therefor is as follows. That is, for example, when a molded article is prepared from a kneaded mass of the carbon nanomaterial and a resin, it is expected to attain the effect of improving an electric conductivity thereof, because the number of fibers filled in a unit volume of the molded article increases as the fiber diameter is finer.

The carbon nanomaterial may be recovered from an upper portion of the fluidized bed reactor 11 using the recovering pipe 14a. Substantially whole amount of the carbon nanomaterial produced may be recovered. The produced carbon nanomaterial is generally recovered in granulated form. The recovering pipe may be made of, for example, stainless steel and may be in the form of a straight pipe.

The flow rate of the fluidizing gas flowing through the recovering pipe 14a for the recovery of the carbon nanomaterial is preferably at least 20 times, more preferably at least 50 times the minimum velocity for the start of fluidization of the carbon nanomaterial. When the flow rate of the fluidizing gas is excessively low, there tends to occasionally occur such a case where the carbon nanomaterial fails to be transferred and recovered. When the flow rate of the fluidizing gas is at least 20 times the minimum fluidization starting velocity, it is possible to smoothly transfer the solid catalyst and fluidizing material so that the feed amount of the catalyst and fluidizing material may be precisely determined.

A part of the carbon nanomaterial to be used as the fluidizing material is transferred from the recovering device 14 to the intermediate hopper 20. The transfer to the intermediate hopper 20 may be carried out by any known feeder such as, for example, a screw feeder. The feeder is preferably selected from those feeders having a metering function from the viewpoint of capability of precisely determining the feed amount.

The transfer of the carbon nanomaterial from the recovering device 14 to the separating device 19 may also be effected by pneumatic transfer.

In the separating device 19, the exhaust gas is separated from the carbon nanomaterial. The separation may be carried out by any known method using, for example, a cyclone, a bag filter, a ceramic filter or a sieve.

The finally obtained carbon nanomaterial is preferably subjected to a pulverizing treatment such as milling, if desired.

### EXAMPLES

The present invention will be described in more detail below by referring to the following suitable examples. However, these examples are only illustrative, and not intended to limit the present invention thereto.

### (Preparation of Supported Catalyst)

In 0.95 μart by mass of methanol, 1.81 μarts by mass of iron nitrate (III) nonahydrate (special grade reagent available from Wako Pure Chemical Industries, Ltd.) was dissolved to obtain a catalyst preparation solution. The catalyst preparation solution was added dropwise to and kneaded with 1 μart by mass of commercially available alumina (fumed alumina; tradename “AEROSIL™ AluC” available from Deggusa Inc.; BET=100 m²/g) to obtain a paste-like mixture. The thus obtained paste-like mixture was dried at 100° C. for 24 h in a vacuum drier and thereafter pulverized and classified to obtain a supported catalyst (amount of Fe supported: 20% by mass) having a size of 45 to 250 μm.

### Example 1

A reactor (diameter: 480 mm; length: 1,440 mm) of a fluidized bed reaction apparatus was charged with 720 g of the supported catalyst prepared above and 3,600 g of previously produced carbon nanotubes (diameter: 13 nm; length: 1.3 μm) as the fluidizing material by pneumatic transfer. Immediately thereafter, while feeding a fluidizing gas (hydrogen; flow rate: 216 L/min) and a carbon raw material (ethylene; flow rate: 216 L/min), the reaction was performed at 550° C. for 30 min in a fluidized state. The blending proportion of the carbon nanotubes ((carbon nanotubes)/(carbon nanotubes+supported catalyst)) was 0.83 and the volume ratio of the hydrogen fed to the ethylene fed (C₂H₄/H₂) was 1.

After completion of the reaction, the reaction gas being fed was changed to a nitrogen gas being fed at a rate of 216 L/min to cool the reactor. Carbon nanotubes thus produced were recovered using a recovering pipe mounted to the apparatus so as to be moveable up and down in the vertical direction. The thus produced carbon nanotubes were measured for a impurity content by a fluorescent X-ray analysis. As a result, it was confirmed that the impurity content was 2.5% by mass. A microphotograph of the obtained carbon material is shown in FIG. 2.

### Examples 2 and 3

The reaction was carried out in the same manner as that in EXAMPLE 1 except that the blending proportion of the carbon nanotubes as the fluidizing material used in EXAMPLE 1 was changed as shown in Table 1 below, and the content of impurities therein was measured. The results are shown in Table 1 below.

TABLE 1

| | EXAMPLE | EXAMPLE | EXAMPLE |
|---|---|---|---|
| | 1 | 2 | 3 |
| Blending proportion of carbon | 83 | 67 | 76 |
| nanotubes (% by mass) | | | |
| Impurity content in carbon | 2.5 | 2.6 | 2.5 |
| nanotubes (% by mass) | | | |

### Comparative Example 1

A reactor (diameter: 480 mm; length: 1,440 mm) of a fluidized bed reaction apparatus was charged with 720 g of the supported catalyst prepared above and 3,600 g of commercially available alumina (average particle diameter: 100 μm) as a fluidizing material by pneumatic transfer. Immediately thereafter, while feeding a fluidizing gas (hydrogen; flow rate: 216 L/min) and a carbon raw material (ethylene; flow rate: 216 L/min), the reaction was performed at 550° C. for 30 min in a fluidized state (the ratio of the catalyst to the fluidizing material was the same as that in EXAMPLE 1). The volume ratio of the hydrogen fed to the ethylene fed (C₂H₄/H₂) was 1.

After completion of the reaction, the reaction gas being fed was changed to a nitrogen gas being fed at a rate of 216 L/min to cool the reactor. Carbon nanotubes thus produced were recovered using a recovering pipe mounted to the apparatus and moveable up and down in the vertical direction. The produced carbon nanotubes were measured for a impurity content by a fluorescent X-ray analysis. As a result, it was confirmed that an Al content increased to 1.5 times that of EXAMPLE 1. Since alumina rather than carbon nanotubes was used as the fluidizing material, it was necessary to conduct a separation step for separating the fluidizing material (alumina) from the carbon nanotubes. The increase of the Al content is considered to be attributed to the use of alumina.

### Example 4

A reactor (diameter: 480 mm; length: 1,440 mm) of a fluidized bed reaction apparatus was charged with 720 g of the supported catalyst prepared above and 3,600 g of previously produced carbon nanotubes as a fluidizing material by pneumatic transfer. Immediately thereafter, while feeding a fluidizing gas (hydrogen; flow rate: 216 L/min) and a carbon raw material (ethylene; flow rate: 216 L/min), the reaction was performed at 550° C. for 30 min in a fluidized state. Three kinds of carbon nanotubes (referred to as Materials 1, 2 and 3) having different aspect ratios as shown in Table 2 below were used. The catalyst was charged so that the product obtained after completion of the reaction had the same properties as those of the fluidizing material. The blending proportion of the carbon nanotubes ((carbon nanotubes)/(carbon nanotubes+supported catalyst)) was 0.83 and the volume ratio of the hydrogen fed to the ethylene fed (C₂H₄/H₂) was 1.

After completion of each of the reactions, the reaction gas being fed was changed to a nitrogen gas being fed at a rate of 216 L/min to cool the reactor. Carbon nanotubes thus produced were recovered using a recovering pipe mounted to the apparatus so as to be moveable up and down in the vertical direction. Each of the obtained carbon nanotube products was mixed and kneaded with a commercially available polycarbonate resin in such an amount that the obtained composite material had a surface resistivity sufficient to provide a suitable antistatic property (10⁶ to 10⁹ Ω/sq.). The results are shown in Table 2 below.

TABLE 2

| | Material 1 | Material 2 | Material 3 |
|---|---|---|---|
| Diameter (nm) | 13 | 80 | 150 |
| Length (μm) | 13 | 10 | 6 |
| Aspect ratio | 1000 | 125 | 40 |
| Addition amount of carbon | 2.5 | 5.0 | 15.0 |
| nanotube to provide a suitable | | | |
| antistatic property (wt %) | | | |

In the TABLE, the “Diameter” was measured with a transmission electron microscope (TEM JEM2010 made by JEOL Ltd.) and the “Length” was measured with a scanning electron microscope (SEM JSM-6390 made by JEOL Ltd.)

### Example 5

A reactor (diameter: 480 mm; length: 1,440 mm) of a fluidized bed reaction apparatus was charged with the supported catalyst prepared above and the fluidizing material used in EXAMPLE 1 by pneumatic transfer while varying proportions (blending proportions) of the fluidizing material to the total amount of the catalyst and the fluidizing material as shown in Table 3. Immediately thereafter, while feeding a fluidizing gas (hydrogen; flow rate: 216 L/min) and a carbon raw material (ethylene; flow rate: 216 L/min) at each blending proportion, the reaction was performed at 550° C. for 30 min in a fluidized state.

After completion of each of the reactions, the reaction gas being fed was changed to a nitrogen gas being fed at a rate of 216 L/min to cool the reactor. Carbon nanotubes thus produced were recovered using a recovering pipe mounted to the apparatus so as to be moveable up and down in the vertical direction. The results are shown in Table 3 below, in which the yield ratios are values calculated on the basis of the yield at a blending proportion of 50% being regarded as 1.

TABLE 3

| | | | |
|---|---|---|---|
| Blending proportion (%) | 25 | 50 | 80 |
| Yield ratio | 0.7 | 1 | 0.98 |
| Impurity content in carbon | 2.8 | 2.3 | 2.4 |
| nanotubes (% by mass) | | | |

When the blending proportion was 25%, the fluidizing state was not maintained in a good condition so that the product recovered was agglomerated.

### Example 6

A reactor (diameter: 480 mm; length: 1,440 mm) of a fluidized bed reaction apparatus was charged with 720 g of the supported catalyst prepared above and 3,600 g of carbon nanotubes previously produced as the fluidizing material used in EXAMPLE 1 by pneumatic transfer, and the contents of the reactor were fluidized with nitrogen gas (flow rate: 216 L/min) for 2 min. Then, while feeding a fluidizing gas (hydrogen; flow rate: 216 L/min) and a carbon raw material (ethylene; flow rate: 216 L/min), the reaction was performed at 550° C. for 30 min in a fluidized state.

After completion of the reaction, the reaction gas being fed was changed to a nitrogen gas being fed at a rate of 216 L/min to cool the reactor. Carbon nanotubes thus produced were recovered using a recovering pipe mounted to the apparatus so as to be moveable up and down in the vertical direction.

As a result, it was confirmed that the yield was increased to 1.1 times that of EXAMPLE 1. The reason therefor is considered to be that the catalyst had been heated beforehand during the mixing step so that the reaction was able to proceed easily. The impurity content in carbon nanotubes was 2.0% by mass, and good results were therefore obtained.

### EXPLANATION OF REFERENCE NUMERALS

11: fluidized bed reactor
12: carbon raw material feeding device
13: catalyst feeding device
14: recovering device
14a: recovering pipe
15,16: heater
17: preheating section
18: fluidizing gas feeding device
19: separating device
20: intermediate hopper

1. A process for producing a carbon nanomaterial, comprising fluidizing a carbon raw material, a catalyst and a fluidizing material in a fluidized bed reactor to produce the carbon nanomaterial, wherein a carbon material is used as the fluidizing material.

2. The process for producing a carbon nanomaterial according to claim 1, wherein the carbon material is a carbon nanomaterial separately obtained by the process according to claim 1.

3. The process for producing a carbon nanomaterial according to claim 1, wherein the carbon material is a carbon nanotube.

4. The process for producing a carbon nanomaterial according to claim 1, wherein the fluidizing material has been previously fluidized in the fluidized bed reactor before initiating a reaction for production of the carbon nanomaterial.

5. The process for producing a carbon nanomaterial according to claim 4, wherein the carbon raw material and fluidizing gas have been previously heated before being fed to the fluidized bed reactor.

6. The process for producing a carbon nanomaterial according to claim 1, wherein the carbon material used as the fluidizing material has a graphite layer.

7. The process for producing a carbon nanomaterial according to claim 1, wherein the catalyst and the fluidizing material have been previously mixed with each other before being introduced into the fluidized bed reactor and wherein the proportion of the fluidizing material is 40% by mass or more and 90% by mass or less on the basis of the total mass of the catalyst and the fluidizing material.

8. A carbon nanomaterial production system for producing a carbon nanomaterial by the process as defined in claim 1, comprising:
a fluidized bed reactor for fluidizing a carbon raw material, a catalyst and a fluidizing material and carrying out a reaction thereof,
a carbon raw material feeding device for feeding the carbon raw material to the fluidized bed reactor,
a catalyst feeding device for feeding the catalyst to the fluidized bed reactor, and
a recovering device for recovering the produced carbon nanomaterial from the fluidized bed reactor,
wherein a part of the recovered carbon nanomaterial is transferred to the catalyst feeding device and used as the fluidizing material.

9. The carbon nanomaterial production system according to claim 8, wherein the recovering device comprises a recovering pipe that is moveable up and down in the vertical direction.
